(19) United States
(12) Patent Application Publication
(10) Pub. No.: US 2026/0104130 A1
(43) Pub. Date: Apr. 16, 2026

(54) TELESCOPIC ROD WITH A STEP

(71) Applicant: Guangdong Sirui Optical Co., Ltd., Zhongshan (CN)

(72) Inventors: Jie Li, Zhongshan (CN); Xiao Fan, Zhongshan (CN)

(73) Assignee: Guangdong Sirui Optical Co., Ltd., Zhongshan (CN)

(21) Appl. No.: 19/206,299

(22) Filed: May 13, 2025

(30) Foreign Application Priority Data
Oct. 15, 2024 (CN) 202411444656.2
Oct. 15, 2024 (CN) 202422502044.6

(51) Int. Cl. F16M 11/14; F16M 11/24; G03B 17/56

(52) U.S. Cl. CPC F16M 11/14; G03B 17/561; F16M 11/242; F16M 2200/022

(57) ABSTRACT

A tripod comprising a main body with a rotating cavity at the upper end, a ball rotatably arranged in the rotating cavity, and a ball swing locking mechanism for locking or releasing the ball; the ball swing locking mechanism comprises a locking assembly that is slidably matched with the main body, a reset elastic member located between the locking assembly and the main body, and a limiting assembly connected to the main body and provided with a movable pin that cooperates with the locking assembly; in response to the locking assembly slides under an external force, the movable pin may be moved and positioned to a locked position or an unlocked position; in the locked position, the locking assembly presses against the ball to limit the axis swing of the ball; in the unlocked position, the locking assembly releases the ball to allow the ball to swing.

### CROSS-REFERENCE TO RELATED APPLICATIONS

This application claims priority to Chinese applications 202422502044.6 and 202411444656.2, both filed on Oct. 15, 2024, whose disclosures are incorporated by reference in their entirety herein.

### TECHNICAL FIELD

Embodiments of the present invention relate to the field of photography accessory equipment technology. In particular, aspects of the invention relate to a supporting stand.

### BACKGROUND

In the field of photographic equipment, a tripod primarily consists of a central base and three legs connected to its outer periphery. The top of the base houses an external mounting assembly, with the central rod attached to this assembly. the lower end of the mounting assembly connects to a rotating ball that is housed within the base's internal cavity. The base also features a locking mechanism to secure the ball in place, while a foot pedal on the exterior drives the locking mechanism's movement.

When photographers use tripods with the central rod for shooting, they must keep the central rod upright and leveled to prevent equipment from tipping over. The traditional method involves first adjusting the central rod to a vertical and upright position, then crouching down to operate the locking mechanism. This process requires manual operation of the locking mechanism, which is both time-consuming and physically demanding. Moreover, the conventional locking mechanism often causes the locking ball to rotate during operation, leading to the central rod deviating from its vertical upright position. This frequently requires repeated locking and unlocking cycles to maintain proper alignment, making the entire process labor-intensive.

### SUMMARY

Therefore, embodiments of the invention provide a supporting stand to address the technical problem of the prior art and attempt to overcome the deficiencies in the locking operation of the ball on the tripod in the prior art is relatively laborious.

In order to solve the above technical problems, the technical solution of aspects of the present invention is as follows:

A supporting stand comprising: a main body of the stand with a rotating chamber at its upper end; a spherical body configured to rotate within a spherical cavity and movable relative to it; and a swing locking mechanism for securing or releasing the spherical body, which is installed inside the main body. The swing locking mechanism includes:

A locking assembly, slidably engaged with the main body;

A resilient or elastic member, where the resilient or elastic member is disposed between the locking assembly and the main body;

A limit component or member, connected to the main body of the tripod, said limit component having a movable pin cooperating with the locking component;

In response to an external force of the locking assembly slides downward, the movable pin may move relative to the locking assembly and be positioned at the locked position or unlocked position on the locking assembly;

In the locked position, the locking assembly presses against the ball to restrict its oscillation relative to the axis of the main body. In the unlocked position, the locking assembly releases the ball to allow its oscillation relative to the axis of the main body.

By implementing the aforementioned technical solution, in response to securing a ball on a supporting stand to maintain stability of the ball and its connected external components, the locking mechanism is depressed and released. The movable pin then moves relative to the locking assembly and locks into the locked position. At this state, the locking mechanism presses against the ball, preventing axial movement relative to the stand's main body. With the reset spring designed for larger dimensions, the locking force exerted by the mechanism becomes stronger, ensuring effective ball retention. Conversely, in response to requiring axial movement of the ball, the locking mechanism is depressed again and released. The pin then moves to the unlocked position, allowing axial movement of the ball. Both locking and unlocking operations for the supporting stand's ball are simple and user-friendly.

Furthermore, in response to the locking assembly is subjected to external downward sliding force, it enables the movable pin to alternately move between a first movable position and a second movable position relative to the locking assembly. Under the action of the reset elastic component, the locking assembly may drive the movable pin from the first movable position to either the locked position or from the second movable position to the unlocked position.

Furthermore, the main body is further provided with a limiting component, which is fixed to the main body in the axial direction and arranged to rotate in the circumferential direction, and the movable pin is radially movably connected to the outer periphery of the limiting component along the radial direction of the limiting component.

Furthermore, a limiting elastic member is arranged between the positioning component and the movable pin. This component drives one end of the movable pin to extend radially outward from the outer surface of the positioning component. The inner wall of the locking assembly features a guide slot, into which the extended portion of the movable pin protruding from the positioning component is inserted.

By implementing the technical solution described above, the locking assembly utilizes a movable pin to drive the positioning component to rotate around its axis while allowing radial movement of the pin. This configuration enables the pin to lock the assembly in either the locked or unlocked positions. The positioning groove on the inner wall of the locking assembly restricts the pin's movement direction, allowing it to slide from the first movable position toward the locked position and from the second movable position toward the unlocked position. This design achieves a simple yet effective operation: in response to the support bracket's locking assembly is pressed down once, the ball swings freely; in response to pressed down again, the ball remains vertical and cannot swing. The structure is straightforward and easy to implement.

Furthermore, the locked position, unlocked position, first movable position, and second movable position are located at different positions on the guide slot. In the axial direction of the locking assembly, the distance between the locked position and the spherical body is greater than that between the first movable position and the spherical body, while the distance between the unlocked position and the spherical body is greater than that between the second movable position and the spherical body. Notably, the distance between the locked position and the spherical body is also greater than that between the unlocked position and the spherical body.

In response to the movable pin is in the locked position and the locking assembly is not subjected to a downward pressing force, the movable pin and the locking assembly abut along the axial direction of the locking assembly to limit the movement of the movable pin from the locked position to the first movable position;

In response to the movable pin is in the locked position and the locking assembly is subjected to a downward pressing force, the movable pin moves from the locked position to the second movable position, the movable pin abuts against the locking assembly to limit the first downward movement stroke of the locking assembly;

In response to the movable pin is in the second movable position and the downward pressing force on the locking assembly disappears, the locking assembly moves upward under the elastic restoring force of the reset spring. The movable pin then transitions from the second movable position to the unlocked position. The movable pin and the locking assembly abut against each other along the axial direction of the locking assembly, thereby restricting the movement of the movable pin from the unlocked position back to the second movable position.

In response to the movable pin is in the unlocked position and the locking assembly is subjected to a downward pressing force, the movable pin moves from the unlocked position to the first movable position, and the movable pin abuts against the locking assembly to limit a second downward travel of the locking assembly.

By implementing the technical solution described above, the guide slot's configuration featuring locked and unlocked positions mechanisms along with first and second movable positions enables the locking assembly to be securely locked in either position. This design allows the assembly to automatically transition between the first and second movable positions via reset spring action, thereby achieving precise positioning under elastic force.

Furthermore, the guide slide groove comprises a first elongated groove, a second elongated groove, a first spiral groove, and a second spiral groove. The length directions of both the first elongated groove and the second elongated groove are parallel to the axial direction main body. The first spiral groove connects at both ends to both the first elongated groove and the second elongated groove, while the second spiral groove also connects at both ends to both grooves.

Through the above technical scheme, the guide slide groove composed of the first elongated groove, the second elongated groove, the first spiral groove and the second spiral groove has a simple structure and is easy to implement.

Furthermore, the depth of the first spiral groove at its connection with the first elongated groove is greater than that of the first elongated groove, enabling the movable pin to slide along the first spiral groove into the second elongated groove. Similarly, the depth of the second spiral groove at its connection with the second elongated groove is greater than that of the second elongated groove, allowing the movable pin to slide along the second spiral groove into the first elongated groove.

Further, the first movable position and the locked position are located at opposite ends of the first elongated groove, and the second movable position and the unlocked position are located at opposite ends of the second elongated groove.

In response to the external components on the supporting stand are in a vertical position, the movable pin is positioned at the junction of the first spiral groove and the first elongated slot. During downward pressing of the locking assembly, as the depth of the first spiral groove's connected end exceeds that of the elongated slot, the pin may only move along the spiral groove. Under the force of the inclined slot, the limit component rotates, causing the pin to continue moving until reaching the junction between the spiral groove and the second elongated slot. The pin then ascends to the upper end of the second elongated slot, preventing further downward movement. In response to releasing the locking assembly, its reset spring returns it to the lower end of the second elongated slot, where the pin locks it. The locking protrusion disengages from the spherical body, allowing free rotation within the cavity. Upon repressing the locking assembly, the second spiral groove's deeper connection end restricts the pin's movement to the second elongated slot. Again, the inclined slot forces rotation of the limit component, guiding the pin to the upper end of the first elongated slot. This prevents further downward movement. Releasing the locking assembly's reset spring returns it to the first elongated slot's lower end, where the pin locks it toward the spherical body. The locking protrusion then engages with the spherical body's socket, securing vertical alignment.

Further, the first elongated groove, the first spiral groove, the second elongated groove and the second spiral groove are arranged in sequence along the circumferential direction of the inner wall surface of the locking assembly;

In response to the number of the guide slide groove is a group, the first strip groove and the second spiral groove are connected at the beginning and the end, and the guide slide groove is through along the circumferential surface of the inner wall of the locking assembly;

In response to multiple guide grooves are arranged in groups, these grooves are evenly distributed circumferentially along the inner wall of the locking assembly. The first elongated groove of the front group connects to the second helical groove of the rear group, with all guide grooves extending circumferentially through the assembly's inner surface. The movable pin may slide alternately within these grouped guide grooves.

Furthermore, the locking assembly includes an outer sleeve and an inner sleeve coaxially arranged with the main body of the tripod, wherein the outer sleeve is slidably engaged with the main body of the tripod and the inner sleeve is fixed inside the outer sleeve, and a guide groove is provided on an inner wall surface of the inner sleeve.

Through the above technical scheme, the locking assembly adopts the separate production and assembly of the outer sleeve and inner sleeve, and the processing of the locking assembly is more convenient.

Further, the inner sleeve is composed of a number of arc-shaped pieces joined together.

Through the above technical scheme, the inner sleeve is composed of multiple arc-shaped pieces spliced at the head and tail, which reduces the difficulty of processing the guide groove in the inner sleeve.

Further, the end of the inner sleeve is provided with a plurality of positioning pins, and the outer sleeve is provided with positioning holes corresponding to the plurality of positioning pins.

Further, the mating surface between the outer sleeve and the main body is an irregular section.

Through the above technical scheme, the mating surface between the outer sleeve and the main body is an irregular section, which may easily realize the relative circumferential fixation of the locking assembly and the main body.

Further, the outer peripheral wall of the sleeve is provided with a plurality of notch grooves, and the groove openings of the notch grooves are opposite to the spherical body.

Through the above technical scheme, the setting of the notch groove on the outer sleeve may reduce the structural strength of the outer peripheral wall of the outer sleeve, and the outer sleeve is easy to undergo slight deformation, which is convenient to assemble the outer sleeve into the main body.

Further, a cavity is formed between the outer sleeve and the inner sleeve, and at least a part of the reset elastic member is accommodated in the cavity.

By adopting the aforementioned technical solution, the reset spring is positioned within a containment cavity between the outer sleeve and inner sleeve. This design allows precise positioning of the spring while maintaining dimensional alignment with the tripod's main body. Since the cavity's outer diameter closely matches that of the tripod's main body, it enables the installation of a high-strength, high-diameter reset spring. This configuration significantly enhances the locking mechanism's effectiveness in securing the spherical component under the spring's action.

Further, the movable pin is provided with a plurality of pins along the circumferential direction of the limiting assembly, and the number of the movable pins is less than or equal to the number of the guiding slide groove.

Through the above technical scheme, the setting of multiple movable pins may improve the reliability of the whole ball swing locking mechanism.

Furthermore, the main body is fixed with a limiting shaft coaxially arranged with the main body. The limiting assembly is rotatably connected to the limiting shaft around its axis, and the limiting shaft is provided with a limiting step blocking the side of the limiting assembly away from the main body.

Through the above technical scheme, the setting of the limit shaft and its upper limit step may improve the stability of the rotation process of the limit assembly, so that the limit assembly rotates around the limit shaft without easy vertical displacement.

Furthermore, the positioning assembly comprises an inner sleeve rotatably connected to the outer circumference of the positioning shaft, and an outer sleeve fixedly sleeved around the outer circumference of the inner sleeve. The outer circumference of the inner sleeve is provided with an installation hole, while the outer circumference of the outer sleeve is provided with a through hole positioned correspondingly to the installation hole. The positioning elastic member is disposed within the installation hole, with one end of the movable pin located inside the installation hole and the other end extending outward through the through hole.

Further, the center of the locking assembly is provided with a central shaft hole, and the central shaft hole is slidably engaged with the limiting shaft along the axial direction of the limiting shaft.

By implementing the technical solution described above, the locking assembly's central shaft bore achieves axial sliding engagement with the positioning shaft. The positioning shaft guides the assembly's movement, ensuring precise axial sliding along its axis. This configuration allows the locking protrusion to accurately position the spherical body vertically, effectively preventing misalignment during locking due to directional deviations in the assembly's motion.

Furthermore, the ball body is provided with a plug hole opening toward the locking assembly, and the end of the locking assembly facing the ball is provided with a locking protrusion, which extends into the plug hole to limit the rotation of the ball relative to the rotating chamber.

By implementing the aforementioned technical solution, in response to connecting support rods to the external components of the tripod stand, maintaining vertical alignment requires only a simple operation: press down and release the locking mechanism. The elastic reset component then moves the locking mechanism from its initial position to the locked state. The locking protrusion extends into the ball's internal slot, exerting outward pressure that prevents axial movement relative to the tripod's main axis. This dual-action locking mechanism—where the protrusion expands outward to secure the ball and slides upward with the locking mechanism—delivers exceptional stability. The protrusion automatically rotates the ball before locking, while the locked state maintains vertical alignment through continuous compression. This streamlined operation eliminates repetitive adjustments, ensuring effortless vertical positioning control.

Further, the locking protrusion is frustum-shaped with a small upper part and a large lower part, and the ball socket is conical in shape identical to that of the locking protrusion.

Further, the upper end of the rotating cavity is provided with a top opening, and the spherical body is connected with a connecting head extending out of the rotating cavity from the top opening; the connecting head is used to connect an external component.

By implementing the aforementioned technical solution, in response to the locking assembly is engaged, the conical protrusion's outer surface tightly abuts against the conical hole wall inside the spherical body. This configuration significantly increases the contact area between both components during locking, thereby enhancing the locking effect. Furthermore, after the spherical body is secured, its external components and support rod remain vertically aligned without deviation.

Further, the external component is used to connect a support rod for supporting a camera equipment or a camera lamp or a camera lampshade.

Furthermore, the interior of the main body is provided with a sliding cavity at the lower end, and the locking assembly is slidably arranged in the sliding cavity along the axial direction of the main body and is fixed circumferentially relative to the main body.

Further, the main body includes a main sleeve and a spherical sleeve arranged coaxially, the rotating cavity is located inside the spherical sleeve, and the sliding cavity is located inside the main sleeve.

Through the above technical scheme, the main body is assembled by the main tube and the spherical tube, which may separate the production and assembly of the corresponding parts, and may reduce the difficulty of production and assembly of the product.

Further, it also includes a pressing member; one end of the pressing member is pivotally connected to the end of the locking assembly facing the ball, and the other end extends outside main body, and the pressing member is used to drive the locking assembly to move away from the ball.

Furthermore, the pressing member comprises an annular body fixedly connected between the main sleeve and the spherical sleeve, positioned between the spherical body and the locking assembly. The annular body features a pivot shaft on its side facing the spherical body. The pressing member also includes a foot pedal with one end rotatably connected to the pivot shaft and the other end extending outward from the side opening of the main body.

Through the above technical solution, the pressing member composed of the annular body and the rotating pedal is adopted, which has a simple structure, easy to assemble and produce, and the pedal is easy to be stepped on by the foot. In response to locking the ball or unlocking the ball, the operator does not need to squat down, and the operation is more convenient.

Further, the locking assembly may pass through the central hole of the annular body, and the pedal is provided with a hole for the locking assembly to pass through.

By adopting the above technical scheme, it is convenient for the pedal to apply an increased downward force on the locking assembly after being pressed down.

Furthermore, the spherical sleeve contains lower and upper damping rings arranged at intervals. These two damping rings form a rotating chamber, with both their central holes having diameters smaller than the spherical body's diameter. The outer wall of the spherical sleeve is threadedly connected to a damping adjustment knob that contacts the upper surface of the upper damping ring. By adjusting this knob, the height of the upper damping ring may be modified, thereby regulating the damping force exerted on the spherical body by both the upper and lower damping rings.

Through the above technical scheme, the damping adjustment knob may be set to adjust the damping force applied by the upper damping ring and the lower damping ring to the spherical body.

Further, at least three support feet are connected to the outer periphery of the main casing.

In summary, the supporting stand provided by this invention employs a spherical locking mechanism with foot pedals. In response to an operator steps on and releases the pedal, the spherical component automatically aligns vertically without deviation. To adjust its orientation, simply press and release the pedal again, allowing the spherical body to swing freely at any angle. This single-step operation enables precise vertical locking or unlocking of the spherical body and its external components and support rods, eliminating the need for repeated adjustments—a truly simplified process that enhances operational convenience.

### BRIEF DESCRIPTION OF THE DRAWINGS

To better illustrate the specific embodiments of this invention or technical solutions in existing technologies, we will briefly introduce the accompanying drawings used in the description. It is evident that the drawings described below represent some embodiments of this invention. For those skilled in the art, additional diagrams may be derived from these illustrations without requiring inventive effort.

FIG. 1 is a three-dimensional structure diagram of the support bracket in an embodiment of the invention;

FIG. 2 is an exploded schematic diagram of the support bracket in an embodiment of the invention;

FIG. 3 is a sectional view of the support bracket in an embodiment of the invention;

FIG. 4 shows the overall structure of the locking assembly in an embodiment of the present invention;

FIG. 5 is an exploded schematic diagram of the locking assembly in an embodiment of the present invention;

FIG. 6 is a schematic diagram of the inner wall guide groove in the inner sleeve in an embodiment of the invention;

FIG. 7 shows a three-dimensional structure diagram of the pressing member in an embodiment of the present invention;

FIG. 8 is a sectional view of the limiting component in an embodiment of the invention.

Reference characters used in the drawings:
1: Leg frame main body; 11: main tube; 111: sliding cavity; 112: side opening; 12: ball sleeve; 13: support foot; 2: Spherical body; 21: connector; 22: socket; 3: External components; 4: Locking assembly; 41: outer sleeve; 411: locking protrusion; 412: notch groove; 42: inner sleeve; 421: guide slide groove; 4211: first elongated groove; 4212: second elongated groove; 4213: first helical groove; 4214: second helical groove; 421a: locked position; 421b: unlocked position; 421c: first movable position; 421d: second movable position; 43: accommodation chamber; 44: locking screw; 45: locating pin; 5: Return elastic member; 6: Pressing piece; 61: annular body; 62: rotating shaft; 63: foot pedal; 631: hole; 7: Limiting component; 71: movable pin; 72: inner sleeve tube; 73: outer sleeve tube; 731: concave cavity; 74: limiting elastic member; 75: flat bearing; 76: locking member; 8: Limiting axis; 81: limiting step; 91. Lower damping ring; 92. Upper damping ring; 10. Damping adjustment knob.

### DETAILED DESCRIPTION

The technical solution of the present invention will be clearly and comprehensively described below with reference to the accompanying drawings. It should be noted that the embodiments described herein constitute only a portion of the embodiments of the present invention, not all of them. Based on these embodiments, all other embodiments obtained by those skilled in the art without making inventive efforts fall within the scope of protection of the present invention.

In the description of this invention, it should be clarified that terms such as “center”, “up”, “down”, “left”, “right”, “vertical”, “horizontal”, “inside”, and “outside” indicate directional or positional relationships based on the orientation shown in the accompanying drawings. These terms are used for convenience in describing the invention and simplifying explanations, not to imply that the described devices or components must possess specific orientations, structural configurations, or operational methods. Therefore, they should not be construed as limiting the scope of the invention. Additionally, terms like “first”, “second”, and “third” are used solely for descriptive purposes and should not be interpreted as indicating relative importance.

In the description of this invention, it should be clarified that unless otherwise explicitly specified or limited, the terms “installation”, “connected”, and “connection” shall be interpreted broadly. These may refer to fixed connections, detachable connections, or integrated connections; mechanical connections or electrical connections; direct connections or indirect connections through intermediaries; or internal communication between two components. For those skilled in the art, the specific meanings of these terms within this invention may be understood based on their contextual application.

In addition, the technical features involved in the different embodiments of the present invention described below may be combined with each other as long as they do not conflict with each other.

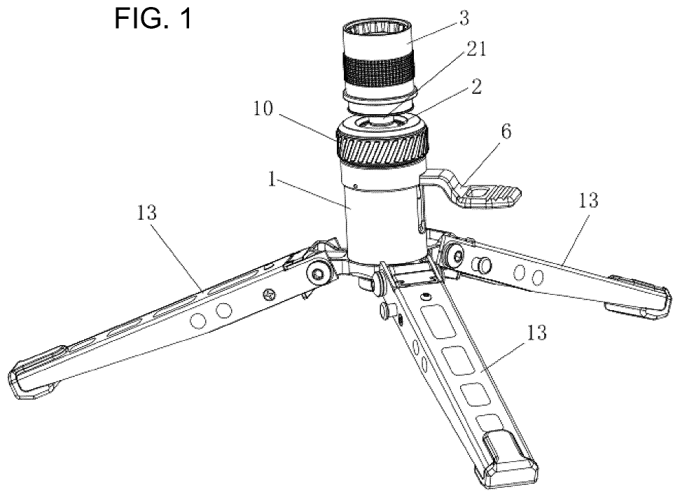

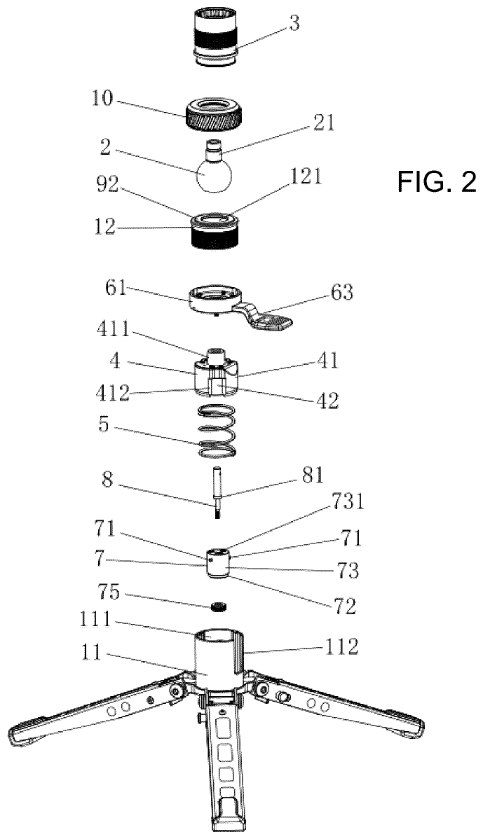

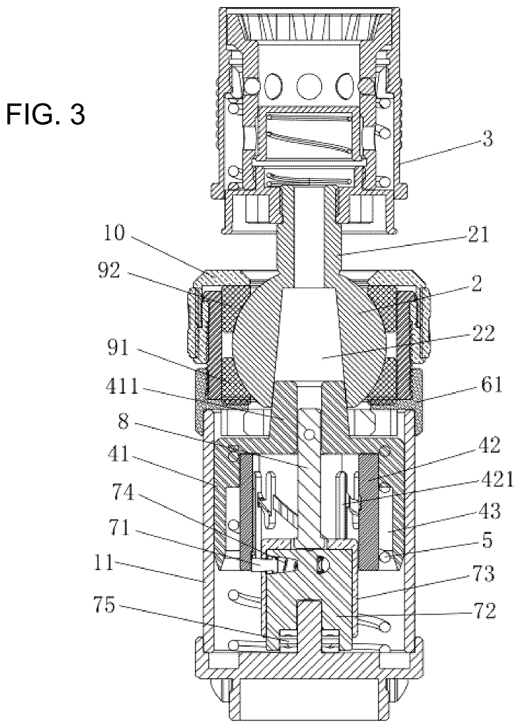

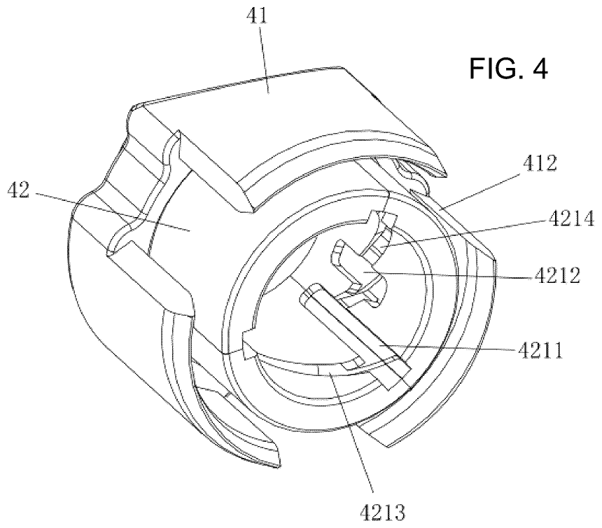

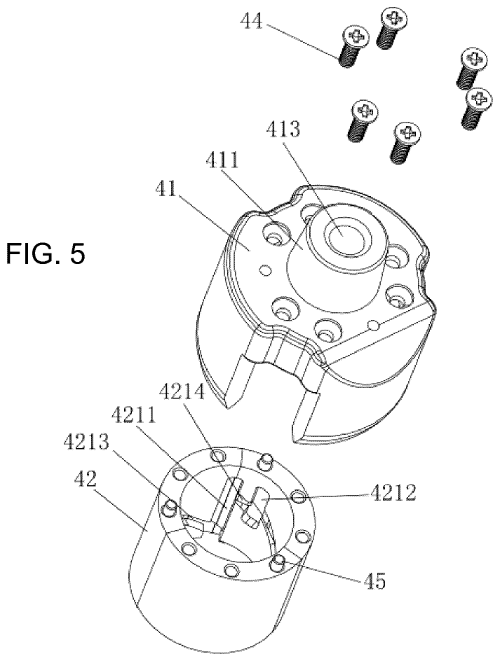

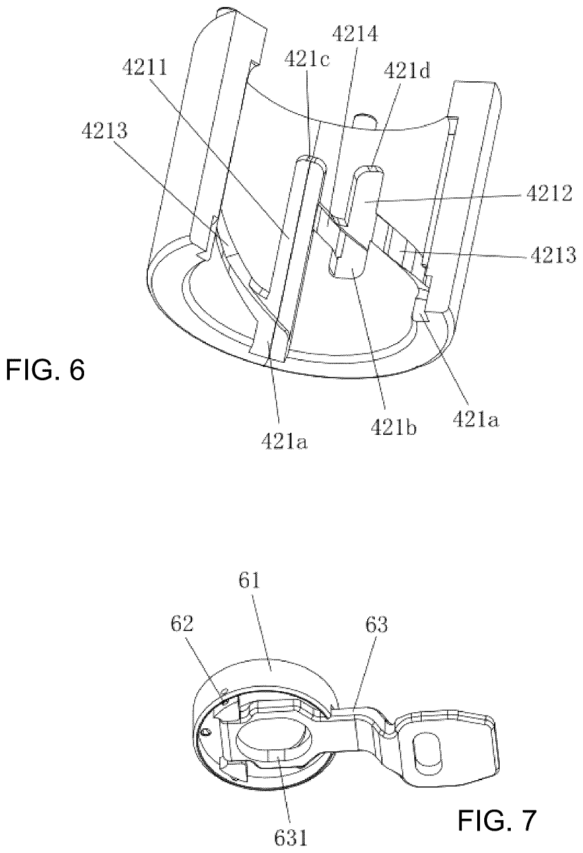

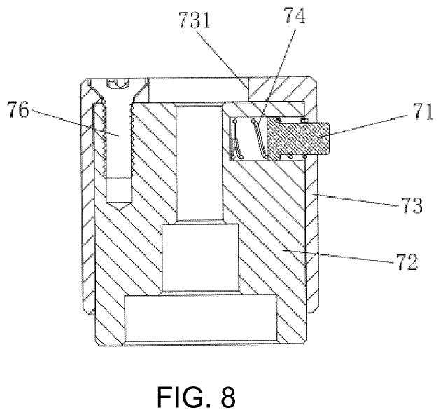

As shown in FIGS. 1-8, this tripod supporting stand is primarily designed for use with the central rod or support poles during photography. The stand consists of three main components: the main body 1, a rotating ball mechanism, and an external component 3. The main body 1 is mounted on the ground, while the rotating ball mechanism is installed on the main body. The external component 3 connects to the upper end of the rotating ball mechanism and serves as a mounting base for the central rod or support poles. These poles may support various photography equipment such as cameras, camcorders, mobile phones, stabilizers, lighting units, and lampshades. The rotating ball mechanism enables secure locking and unlocking of the external component. In response to locked, it maintains vertical alignment between the external component and its attached poles. In response to unlocked, the poles swing freely around the main body's central axis.

The main body 1 of the tripod adopts an internally hollow tubular structure. Inside this body, there are a rotating chamber at the top and a sliding chamber 111 at the bottom. The sliding chamber 111 features a sealed bottom wall with side openings 112 on its sides. Its upper end connects to the lower end of the rotating chamber, while the rotating chamber's top opening is positioned at the upper end.

In this embodiment, spherical body 2 is confined within the spherical surface formed by the rotating chamber and is rotatably mounted relative to it. The upper end of spherical body 2 integrally forms a connector 21 that extends outward from the top opening of the rotating chamber, with an external component 3 fixed on the connector 21. The swing locking mechanism for the spherical body comprises a locking assembly 4, a reset elastic member 5, and a positioning assembly 7. The locking assembly 4 is slidably arranged in the sliding chamber 111 along the axial direction of the main body 1 and is circumferentially fixed to the main body 1. The reset elastic member 5 is elastically positioned between the locking assembly 4 and the main body 1, serving to drive the locking assembly 4 toward the spherical body 2. The positioning assembly 7 is connected to the main body 1 and features a movable pin 71 that cooperates with the locking assembly 4.

In response to the locking assembly 4 is subjected to external downward force, it causes the movable pin 71 to move relative to the locking assembly and position at either the locked position 421a or unlocked position 421b. At the locked position 421a, the locking assembly 4 presses against the ball 2 to restrict its oscillation relative to the axis of the main body 1. At the unlocked position 421b, the locking assembly 4 releases the ball 2 to allow its oscillation relative to the main body 1's axis. In response to the locking assembly 4 slides downward under external force, it also enables the movable pin 71 to alternately move between the first movable position 421c and second movable position 421d on the locking assembly 4. Under the action of the reset spring (5), the locking assembly (4) may drive the movable pin 71 to either move from the first movable position 421c to the locked position 421a or from the second movable position 421d to the unlocked position 421b.

Under external force, the locking assembly 4 alternately moves between the first movable position 421c and second movable position 421d. Driven by the reset spring 5, the locking assembly 4 either moves from the first movable position 421c to the locked position 421a or from the second movable position 421d to the unlocked position 421b. The limiting component 7 secures the locking assembly 4 at both the locked position 421a and unlocked position 421b, while the movable pin 71 maintains the locking assembly 4 within the first movable position 421c and second movable position 421d. In response to the movable pin 71 is in the locked position 421a, the locking assembly 4 presses against the ball 2 to restrict its axial movement relative to the main body 1, thereby locking the assembly at the locked position 421a. In response to the movable pin 71 is in the unlocked position 421b, the locking assembly 4 releases the ball 2 to allow axial movement relative to the main body 1, locking the assembly at the unlocked position 421b. The movable pin 71 restricts the first downward stroke of the locking assembly 4 in response to in the first movable position 421c, and limits the second downward stroke in response to in the second movable position 421d.

The supporting stand further includes a pressing member 6, one end of which acts on the locking assembly 4 toward the spherical body 2 and the other end extends out main body 1 from the side opening 112; the pressing member 6 is used to drive the locking assembly 4 to move away from the spherical body 2.

This supporting stand mechanism enables vertical locking of external components (e.g., the central rod or support rods) connected to the tripod. In response to locking, pressing down and releasing the compression member 6 causes the locking assembly 4 to move from the first movable position 421c to the locked position 421a under the reset spring 5. The locking assembly 4 then presses upward against the ball 2, with the movable pin 71 and locking assembly 4 maintaining axial contact. This locks the ball 2 in vertical alignment, keeping both the external component 3 and the connected the central rod/stake rod fixed vertically. To enable rotation around the tripod's axis, simply press down and release the compression member 6 again. The locking assembly 4 then moves from the second movable position 421d to the unlocked position 421b under the reset spring 5, releasing the ball 2. The movable pin 71 and locking assembly 4 resume axial contact, allowing the ball 2 to rotate freely within the tripod's axis. This single-action mechanism achieves both locking and unlocking of the ball 2, offering exceptional simplicity that significantly enhances the product's competitiveness.

In certain embodiments, the spherical body 2 is provided with a socket 22 opening toward the locking assembly 4. The end of the locking assembly 4 facing the spherical body 2 features a locking protrusion 411 that protrudes outward from the spherical body 2. This locking protrusion 411 may extend into the socket 22 to restrict rotational movement of the spherical body 2 relative to the rotating chamber. In response to the locking assembly 4 is engaged, its locking protrusion 411 retracts into the socket within the spherical body 2, exerting inward pressure to prevent rotational movement. This mechanism of utilizing the locking protrusion 411 to expand the spherical body 2 from the inside out not only ensures excellent locking performance but also ensures precise control. Since the locking protrusion 411 may only slide upward into the socket within the spherical body 2, it automatically rotates the spherical body 2 before reaching the locked position. Upon engagement, the spherical body 2 is secured by the locking protrusion 411, maintaining its external component 3 in a vertical orientation. Once tightened, the external component 3 remains vertically aligned, allowing simple operation to lock or release the spherical body 2 in either vertical or horizontal positions without requiring repeated adjustments. In alternative embodiments, the socket 22 may be omitted from the spherical body 2, and the locking assembly 4 may lack the locking protrusion 411. Instead, the locking assembly 4 may directly or indirectly contact the lower end of the spherical body 2 to achieve secure locking or unlocking. In some alternative embodiments, a damping pad seat is provided in the main body 1 of the tripod 1 between the ball 2 and the locking assembly 4. The damping pad seat defines a portion of the outer spherical surface of the rotating cavity. The locking assembly 4 is actuated to move upward through the damping pad seat, thereby locking the ball 2 using the damping pad seat.

In certain embodiments, the locking protrusion 411 is designed as a frustum with a smaller top and larger bottom, while the ball 2's socket 22 features a conical shape matching its contour. In response to the locking assembly 4 is engaged, the frustum-shaped protrusion's outer surface tightly engages with the conical hole wall inside the ball 2, significantly increasing the contact area between them during locking to enhance secure retention. Furthermore, after the ball 2 is locked, its external component 3 and support rod remain vertically aligned without deviation.

In some embodiments, the limit component 7 is arranged inside the main body 1, while the locking assembly 4 contains an internal cavity. In response to the locking assembly 4 slides vertically, the limit component 7 may extend into the cavity of the locking assembly 4. The limit component 7 is axially fixed relative to the main body 1 and rotationally mounted around its circumference. A movable pin 71 is radially connected to the limit component 7, which serves to lock the locking assembly 4 in either the locked position 421a or unlocked position 421b. In response to the locking assembly 4 slides downward under the pressure of the pressing member 6, it drives the limit component 7 to rotate around its axis vi the movable pin 71. In response to the locking assembly 4 rebounds upward under the elastic force of the reset spring 5, the movable pin 71 remains stationary but moves linearly between the first movable position 421c and the locked position 421a, or between the second movable position 421d and the unlocked position 421b. Alternatively, the limit component 7 may be positioned externally on either the locking assembly 4 or the main body 1, provided it may securely lock the locking assembly 4 in either the locked position 421a or unlocked position 421b. The limit component 7 may be positioned at specific locations individually or in multiple units, each serving to lock or limit the locking assembly 4 at different positions.

In certain embodiments, a positioning spring 74 is arranged between the limit component 7 and the movable pin 71. This spring drives one end of the movable pin 71 to extend radially outward from the outer surface of the limit component 7. The inner wall of the locking assembly 4 features a guide groove 421, into which the extended portion of the movable pin 71 enters. The design of this guide groove on the locking assembly's inner surface restricts the pin's movement direction, enabling it to lock or unlock the locking assembly 4 at either locked position 421a or unlocked position 421b. The pin may slide between the first movable position 421c (locked position) and the second movable position 421d (unlocked position), allowing the support bracket to be locked and unlocked with a single operation for enhanced convenience. During locked state, the spherical body 2 and its external component 3 remain vertically aligned; in unlocked state, both the spherical body 2 and its external component 3 may swing freely.

In certain embodiments, the locked position 421a, unlocked position 421b, first movable position 421c, and second movable position 421d are positioned at different locations on the guide slot 421. In the axial direction of the locking assembly 4, the distance between the locked position 421a and spherical body 2 is greater than that between the first movable position 421c and spherical body 2, while the distance between the unlocked position 421b and spherical body 2 is greater than that between the second movable position 421d and spherical body 2. The locked position 421a and spherical body 2 maintain a greater distance than the unlocked position 421b and spherical body 2. In response to the movable pin 71 is in the locked position 421a and the locking assembly 4 is not subjected to downward pressure, the movable pin 71 abuts against the locking assembly 4 along its axial direction to prevent movement from the locked position 421a to the first movable position 421c. In response to the movable pin 71 is in the locked position 421a and the locking assembly 4 is subjected to downward pressure from the pressing member 6, the movable pin 71 moves from the locked position 421a to the second movable position 421d, thereby contacting the locking assembly 4 to limit the first downward travel of the locking assembly 4. In response to the movable pin 71 is in the second movable position 421d and the downward pressing force on the locking assembly 4 from the pressing member 6 disappears, the locking assembly 4 moves upward under the elastic restoring force of the reset spring 5. The movable pin 71 then transitions from the second movable position 421d to the unlocked position 421b. The movable pin 71 and the locking assembly 4 abut against each other along the axial direction of the locking assembly 4, preventing it from moving back to the second movable position 421d. In response to the movable pin 71 is in the unlocked position 421b and the locking assembly 4 again receives downward pressing force from the pressing member 6, the movable pin 71 moves from the unlocked position 421b to the first movable position 421c. The movable pin 71 then contacts the locking assembly 4 to limit its second downward movement stroke. The configuration of the guide slot 421 with the locked position 421a, unlocked position 421b, first movable position 421c, and second movable position 421d allows the locking assembly 4 to be locked at both the locked position 421a and unlocked position 421b. Under the action of the reset spring 5, the locking assembly 4 may automatically move from the first movable position 421c to the locked position 421a, and from the second movable position 421d to the unlocked position 421b.

In some embodiments, the guide slot 421 comprises a first elongated groove 4211, a second elongated groove 4212, a first helical groove 4213, and a second helical groove 4214. The length directions of the first elongated groove 4211 and the second elongated groove 4212 are parallel to the axial direction of the main body 1. The first helical groove 4213 connects to both ends of the first elongated groove 4211 and the second elongated groove 4212, while the second helical groove 4214 connects to both ends of the first elongated groove 4211 and the second elongated groove 4212. The length of the first elongated groove 4211 is longer than that of the second elongated groove 4212, and the length of the first helical groove 4213 is longer than that of the second helical groove 4214. The first movable position 421c and locked position 421a are located at opposite ends of the first elongated groove 4211, while the second movable position 421d and unlocked position 421b are located at opposite ends of the second elongated groove 4212. Specifically, the locked position 421a is positioned at the end where the first helical groove 4213 connects to the first elongated groove 4211, and the unlocked position 421b is positioned at the end where the second helical groove 4214 connects to the second elongated groove 4212. The guide slot 421, composed of the first elongated groove 4211, second elongated groove 4212, first helical groove 4213, and second helical groove 4214, features a simple structure that is easy to implement.

In certain embodiments, the depth of the first spiral groove 4213 connected to the first elongated groove 4211 is greater than that of the first elongated groove 4211, allowing the movable pin 71 to slide along the first spiral groove 4213 into the second elongated groove 4212. Similarly, the depth of the second spiral groove 4214 connected to the second elongated groove 4212 is greater than that of the second elongated groove 4212, enabling the movable pin 71 to slide along the second spiral groove 4214 into the first elongated groove 4211. In response to the external component 3 on the support bracket is in a vertical position, the movable pin 71 is positioned at the junction between the first spiral groove 4213 and the first elongated groove 4211. By pressing down the pressing member 6, it exerts downward force on the locking assembly 4, causing the locking assembly 4 to descend. During this downward movement, since the depth of the first spiral groove 4213 connected to the first elongated groove 4211 exceeds that of the first elongated groove 4211, the movable pin 71 may only move along the first spiral groove 4213. Under the influence of the inclined groove force, the limiting assembly 7 rotates. The movable pin 71 then continues moving until it reaches the junction between the first spiral groove 4213 and the second elongated groove 4212, subsequently moving to the upper end of the second elongated groove 4212. At this point, the locking assembly 4 cannot be pressed downward further. Upon releasing the pressing member 6, the locking assembly 4 returns to its original position under the action of the reset spring 5, locking at the lower end of the second elongated groove 4212 with the movable pin 71. Meanwhile, the locking protrusion 411 disengages from the spherical body 2, allowing the spherical body 2 to rotate freely within the rotating chamber. Press component 6 is pressed down again, applying downward force to locking assembly 4. As the assembly moves downward, the second spiral groove 4214 connects with the second elongated groove 4212 at a depth greater than that of the elongated groove itself. This restricts the movable pin 71 to slide only along the spiral groove. Under the inclined groove force, the limit component 7 rotates, causing the movable pin 71 to reach the upper end of the first elongated groove 4211. At this point, locking assembly 4 may no longer be pressed down. In response to releasing press component 6, the assembly returns to its original position under the reset spring 5, moving to the lower end of the first elongated groove 4211 where it locks the movable pin 71. The locking assembly then moves toward spherical body 2 until the locking protrusion 411 engages with the socket 22 inside spherical body 2, securing the spherical body vertically.

In some embodiments, the first elongated groove 4211, first helical groove 4213, second elongated groove 4212, and second helical groove 4214 are arranged circumferentially along the inner wall of the locking assembly 4. The guide grooves 421 are grouped in sets, with the first elongated groove 4211 and second helical groove 4214 being connected end-to-end, while the guide grooves 421 extend circumferentially along the inner wall of the locking assembly 4. In another embodiment, multiple sets of guide grooves 421 are arranged circumferentially along the inner wall of the locking assembly 4. The first elongated groove 4211 of the front set of guide grooves 421 connects to the second helical groove 4214 of the rear set, while the multiple sets of guide grooves 421 extend circumferentially along the inner wall of the locking assembly 4. The movable pin 71 may slide alternately within these multiple sets of guide grooves 421.

In certain embodiments, three movable pins 71 are evenly distributed circumferentially along the positioning assembly 7, with their quantity matching that of the guide grooves 421. This configuration enhances the overall reliability of the locking mechanism. It should be noted that the number of movable pins 71 may be reduced below the number of guide grooves 421, for instance, using two movable pins 71 instead.

In certain embodiments, the locking assembly 4 comprises an outer sleeve 41 coaxially arranged with the main body 1 and an inner sleeve 42. The outer sleeve 41 is slidably engaged with the sliding chamber 111, while the inner sleeve 42 is secured within the outer sleeve 41 via multiple locking screws. A guide groove 421 is recessed on the inner wall of the inner sleeve 42. The inner sleeve 42 features multiple positioning pins 45 at its end, which correspond to positioning holes in the outer sleeve 41. The locking assembly 4 is manufactured through separate production of the outer sleeve 41 and inner sleeve 42, followed by assembly, resulting in simplified manufacturing processes.

In some embodiments, the inner sleeve 42 is formed by joining three arc-shaped pieces together. In this way, it is possible to reduce the difficulty of machining the guide groove 421 in the inner sleeve 42.

In some embodiments, the mating surface between the outer sleeve 41 and main body 1 is an irregular cross section; thus, it is easy to achieve the relative circumferential fixing of the locking assembly 4 and main body 1, and the assembly is simple.

In certain embodiments, the outer peripheral wall of sleeve 41 features three notched grooves 412, with their openings facing away from spherical body 2. This design reduces structural rigidity of the sleeve, allowing its outer wall to undergo minor deformation. This configuration facilitates easy assembly of the sleeve into the sliding cavity 111 of the tripod base 1.

In certain embodiments, a housing cavity 43 is formed between the outer sleeve 41 and inner sleeve 42, with the reset spring 5 partially housed within this cavity. This configuration allows the locking assembly 4 to position the reset spring 5 through the cavity. As the outer diameter of the housing cavity closely matches that of the main body 1, the use of a high-diameter, high-stiffness reset spring 5 enables enhanced locking performance in response to applied by the locking assembly 4 to the spherical component 2.

In certain embodiments, the main body 1 of the tripod is internally fixed with a positioning shaft 8 coaxially arranged. The positioning assembly 7 is rotatably connected to the positioning shaft 8 along its axis, and a positioning step 81 is provided on the positioning shaft 8 to block the side of the positioning assembly 7 away from the main body. The configuration of the positioning shaft 8 and its upper positioning step 81 enhances stability during rotation, preventing vertical displacement in response to the positioning assembly 7 rotates around the positioning shaft 8. The positioning assembly 7 consists of an inner sleeve 72 rotatably connected to the outer circumference of the positioning shaft 8, and an outer sleeve 73 fixedly mounted around the inner sleeve 72. The outer circumference of the inner sleeve 72 features mounting holes, while the outer circumference of the outer sleeve 73 has corresponding through-holes. A positioning elastic member 74 is installed in the mounting holes, with a movable pin 71 extending outward from the through-hole at one end. The outer sleeve 73 is provided with a recess 731 that matches the positioning step 81 on the positioning shaft 8.

In certain embodiments, the outer sleeve 41 features a central shaft hole aligned with the positioning shaft 8 for axial sliding engagement. This configuration enables the positioning shaft 8 to guide the sliding movement of the locking assembly 4, ensuring precise axial alignment. Consequently, the locking protrusion 411 on the assembly may accurately position the spherical body 2 vertically, effectively preventing misalignment that might occur in response to the assembly's motion direction deviates during locking operations.

In certain embodiments, the main body 1 comprises coaxially arranged main sleeve 11 and spherical sleeve 12. The rotating chamber is located within the spherical sleeve 12, while the sliding chamber 111 resides inside the main sleeve 11. By adopting an assembly method combining both sleeves, the main body 1 enables separate production and assembly of corresponding components, thereby reducing the complexity of product manufacturing and assembly.

In certain embodiments, the pressing member 6 comprises an annular body 61 fixedly connected between the main sleeve 11 and the spherical sleeve 12. This annular body 61 is positioned between the spherical body 2 and the locking assembly 4. The side of the annular body 61 facing the spherical body 2 is equipped with a pivot shaft 62. The pressing member 6 also includes a footrest 63 that is rotatably connected to one end of the pivot shaft 62 and extends outward from the side opening 112 of the main body 1 at its other end. The configuration of the pressing member 6, which combines the annular body 61 with a rotatable footrest 63, features a simple structure that facilitates assembly and production. The footrest 63's easy-to-step-on design allows operators to lock or unlock the spherical body 2 without squatting, significantly enhancing operational convenience. The locking boss passes through the central hole in the annular body 61, while the footrest 63 has a corresponding hole for the locking boss. This arrangement enables the footrest 63 to apply increased downward pressure on the locking assembly 4 when depressed.

In certain embodiments, the spherical sleeve 12 contains lower damping ring 91 and upper damping ring 92 arranged at intervals. These two rings form a rotating chamber, with both the central holes of the lower and upper damping rings having diameters smaller than that of the spherical body 2. The outer wall of the spherical sleeve 12 is threadedly connected to a damping adjustment knob 10, which abuts against the upper surface of the upper damping ring 92. By adjusting the damping adjustment knob 10, the height of the upper damping ring 92 may be modified, thereby regulating the damping force exerted on the spherical body 2 by both the upper and lower damping rings 91.

In summary, the supporting stand provided by this invention employs a foot-operated spherical locking mechanism. When an operator presses and releases pedal 63, the spherical component automatically aligns vertically without deviation. To adjust its orientation, simply press and release pedal 63 again, allowing the spherical component to swing freely at any angle. This single operation enables precise vertical locking or unlocking of the spherical component, eliminating the need for repeated adjustments to secure the spherical component, its external assembly 3, and support rod in a vertical position. The simplified operation significantly enhances user convenience.

The embodiments of the invention may be protected by the following claims:

A supporting stand or tripod comprising: a main body (1) of the stand frame with a rotating cavity at its upper end; a spherical body (2) restricted within the spherical cavity and rotatably mounted relative to it; and a swinging locking mechanism (SWLM) disposed inside the main body (1) for securing or releasing the spherical body (2). The SWLM comprises:

Locking assembly (4), which is slidably engaged with the main body (1);

The resilient return member (5) is elastically disposed between the locking assembly (4) and main body (1);

The limiting component (7) is connected to the main body of the tripod (1), and the limiting component (7) has a movable pin (71) which cooperates with the locking component (4);

In response to the locking assembly (4) slides under an external force, the movable pin (71) may move relative to the locking assembly (4) and be positioned to the locked position (421a) or unlocked position (421b) on the locking assembly (4)

In the locked position (421a), the locking component (4) presses against the ball (2) to restrict its oscillation relative to the axis of the main body (1). In the unlocked position (421b), the locking component (4) releases the ball (2) to allow its oscillation relative to the axis of the main body (1).
2. The supporting stand of claim 1, wherein: in response to the locking assembly (4) slides downward under external force, it causes the movable pin (71) to alternately move between a first movable position (421c) and a second movable position (421d) on the locking assembly (4). Under the action of the reset elastic member (5), the locking assembly (4) enables the movable pin (71) to either move from the first movable position (421c) to the locked position (421a), or from the second movable position (421d) to the unlocked position (421b).
3. The supporting stand of claim 2, wherein the limiting component (7) is fixed axially relative to the main body (1) and arranged for circumferential rotation, while the movable pin (71) is radially movably connected to the outer periphery of the limiting component (7).
4. The supporting stand of claim 3, wherein: a limiting elastic member (74) being disposed between the limiting component (7) and the movable pin (71), said limiting elastic member (74) driving one end of the movable pin (71) to extend radially outward from the outer surface of the limiting component (7); and a locking component (4) having an inner wall with a guide groove (421), wherein the extended end of the movable pin (71) protruding from the limiting component (7) is inserted into the guide groove (421).
5. The supporting stand of claim 4, wherein the locked position (421a), unlocked position (421b), first movable position (421c), and second movable position (421d) are located at different positions on the guide slot (421); along the axial direction of the locking assembly (4), the distance between the locked position (421a) and the spherical body (2) is greater than the distance between the first movable position (421c) and the spherical body (2), the distance between the unlocked position (421b) and the spherical body (2) is greater than the distance between the second movable position (421d) and the spherical body (2), and the distance between the locked position (421a) and the spherical body (2) is greater than the distance between the unlocked position (421b) and the spherical body (2);

In response to the movable pin (71) is in the locked position (421a) and the locking assembly (4) is not subjected to a downward force, the movable pin (71) and the locking assembly (4) abut against each other along the axial direction of the locking assembly (4), thereby restricting the movable pin (71) from moving from the locked position (421a) to the first movable position (421c);

In response to the movable pin (71) is in the locked position (421a) and the locking assembly (4) is subjected to a downward force, the movable pin (71) moves from the locked position (421a) to the second movable position (421d). The movable pin (71) abuts against the locking assembly (4) to define the first downward travel of the locking assembly (4);

In response to the movable pin (71) is in the second movable position (421d) and the downward force on the locking assembly (4) disappears, the locking assembly (4) moves upward under the elastic restoring force of the reset spring (5). The movable pin (71) then transitions from the second movable position (421d) to the unlocked position (421b). The movable pin (71) and the locking assembly (4) abut against each other along the axial direction of the locking assembly (4), thereby preventing the movable pin (71) from moving back to the second movable position (421d) from the unlocked position (421b).

In response to the movable pin (71) is in the unlocked position (421b) and the locking assembly (4) is subjected to a downward force, the movable pin (71) moves from the unlocked position (421b) to the first movable position (421c). The movable pin (71) then contacts the locking assembly (4), thereby defining the second downward travel of the locking assembly (4).
6. The supporting stand of claim 5, wherein the guide slide groove (421) comprises a first elongated groove (4211), a second elongated groove (4212), a first spiral groove (4213), and a second spiral groove (4214). The length directions of the first elongated groove (4211) and the second elongated groove are parallel to the axial direction of the main body (1). The first spiral groove (4213) has both ends connected to the first elongated groove (4211) and the second elongated groove (4212), while the second spiral groove (4214) has both ends connected to the first elongated groove (4211) and the second elongated groove (4212).
7. The supporting stand of claim 6, wherein (a) the depth of the first spiral groove (4213) at its connection with the first elongated groove (4211) is greater than that of the first elongated groove (4211), enabling the movable pin (71) to slide along the first spiral groove (4213) into the second elongated groove (4212); (b) the depth of the second spiral groove (4214) at its connection with the second elongated groove (4212) is greater than that of the second elongated groove (4212), allowing the movable pin (71) to slide along the second spiral groove (4214) into the first elongated groove (4211).
8. The supporting stand of claim 7, wherein: the first movable position (421c) and the locked position (421a) are located at opposite ends of the first elongated groove (4211), while the second movable position (421d) and the unlocked position (421b) are positioned at opposite ends of the second elongated groove (4212).
9. The supporting stand of claim 6, wherein the first elongated groove (4211), the first spiral groove (4213), the second elongated groove (4212) and the second spiral groove (4214) are arranged in sequence along the circumferential direction of the inner wall surface of the locking assembly (4);

In response to the number of the guide slide groove (421) is a group, the first strip groove (4211) and the second spiral groove (4214) are connected at the beginning and end, and the guide slide groove (421) is through along the circumferential surface of the inner wall of the locking assembly (4);

In response to multiple guide grooves (421) are arranged in groups, these grooves are evenly distributed circumferentially along the inner wall of the locking assembly (4). The first elongated groove (4211) of a front group connects to the second helical groove (4214) of a rear group, with all guide grooves extending through the locking assembly's inner wall. The movable pin (71) may slide alternately within these grouped guide grooves.
10. The supporting stand according to any one of claims 4-9, wherein the locking assembly (4) comprises an outer sleeve (41) coaxially arranged with the main body (1) and an inner sleeve (42). The outer sleeve (41) is slidably engaged with the main body (1), while the inner sleeve (42) is fixed inside the outer sleeve (41). A guide slide groove (421) is provided on the inner wall surface of the inner sleeve (42).
11. The supporting stand of claim 10, wherein the inner sleeve (42) is formed by splicing together a plurality of arc-shaped plates.
12. The supporting stand of claim 10, wherein the outer peripheral wall of the outer sleeve (41) is provided with a plurality of notch grooves (412), and the groove opening of the notch grooves (412) is opposite to the spherical body (2).
13. The supporting stand of claim 10, wherein a housing cavity (43) is formed between the outer sleeve (41) and the inner sleeve (42), and the reset elastic member (5) is at least partially accommodated in the housing cavity (43).
14. The supporting stand of claim 3, wherein: a positioning shaft (8) coaxially arranged with the main body (1) is fixed inside the main body (1); the positioning assembly (7) is rotatably connected to the positioning shaft (8) around its axis; and a positioning step (81) is provided on the positioning shaft (8) to block the side of the positioning assembly (7) away from the main body (1).
15. The supporting stand of claim 14, wherein the locking assembly (4) has a central shaft hole at its center, and the central shaft hole is slidably engaged with the limiting shaft (8) along the axial direction of the limiting shaft (8).
16. The supporting stand of claim 1, wherein the spherical body (2) is provided with a hole opening toward a plug hole (22) of the locking assembly (4); the locking assembly (4) has a locking protrusion (411) at its end facing the spherical body (2); said locking protrusion (411) extends into said plug hole (22) to restrict the spherical body (2) from swinging relative to the axis of the main body (1) of the stand.
17. The supporting stand of claim 16, wherein the locking protrusion (411) is frustum-shaped with a small upper part and a large lower part, and the insertion hole (22) of the spherical body (2) is conical in shape identical to the locking protrusion (411).
18. The supporting stand of claim 1, wherein the upper end of the rotating cavity is provided with a top opening, and the spherical body (2) is connected with a connecting head (21) extending out of the rotating cavity from the top opening; the connecting head (21) is used for connecting an external component (3).
19. The supporting stand of claim 18, wherein the external component (3) is used to connect a support rod or the central rod for supporting photographic equipment.
20. The supporting stand of claim 1, wherein the main body (1) of the leg frame further comprises a sliding cavity (111) located at the lower end. The locking assembly (4) is slidably arranged along the axial direction of the main body (1) within the sliding cavity (111), and is circumferentially fixed relative to the main body (1).
21. The supporting stand of claim 20, wherein the main body (1) comprises a coaxially arranged main sleeve (11) and a spherical sleeve (12), wherein the rotating cavity is located inside the spherical sleeve (12), and the sliding cavity (111) is located inside the main sleeve (11).
22. The supporting stand of claim 21, wherein it further comprises a pressing member (6); one end of the pressing member (6) is pivotally connected to the locking assembly (4) facing the spherical body (2), while the other end extends outside the main body (1). The pressing member (6) is configured to drive the locking assembly (4) to move away from the spherical body (2).
23. The supporting stand of claim 22, wherein the pressing member (6) comprises an annular body (61) fixedly connected between the main sleeve (11) and the spherical sleeve (12), with said annular body (61) positioned between the spherical body (2) and the locking assembly (4). The annular body (61) has a pivot shaft (62) on its side facing the spherical body (2), and the pressing member (6) further includes a foot pedal (63) whose one end is rotatably connected to the pivot shaft (62) while the other end extends outside main body (1).
24. The supporting stand of claim 23, wherein the pedal (63) is provided with a hole for the locking assembly (4) to pass through.
25. The supporting stand of claim 21, wherein the spherical sleeve (12) contains lower damping ring (91) and upper damping ring (92) arranged at intervals, forming a rotating chamber; both the lower damping ring (91) and upper damping ring (92) have central holes with diameters smaller than the diameter of the spherical body (2); the outer wall of the spherical sleeve (12) is threadedly connected to a damping adjustment knob (10), which abuts against the upper surface of the upper damping ring (92); the damping adjustment knob (10) regulates the damping force applied by the upper damping ring (92) and lower damping ring (91) to the spherical body (2).

Clearly, the embodiments described above are provided for illustrative purposes and are not intended to limit the scope of implementation. Those skilled in the art may make various modifications or variations based on this description. It is neither necessary nor possible to exhaustively enumerate all possible implementations. Any obvious modifications or variations derived from this context remain within the scope of protection of the present invention.

1. A supporting stand comprising:
a main body having a rotating cavity at its upper end;
a spherical body restricted within the spherical cavity and rotatably mounted relative to it; and a swinging locking mechanism disposed within the main body for securing or releasing the spherical body, wherein the swinging locking mechanism comprises:
a locking assembly for slidably engaged with main body;
a resilient return member being elastically disposed between the locking assembly and main body;
a limiting component connected to the main body, and the limiting component comprises a movable pin configured to cooperate with the locking component;
in response to the locking assembly sliding under an external force, a movable pin is configured to move relative to the locking assembly and be positioned to a locked position or an unlocked position on the locking assembly;
wherein in the locked position, the locking component presses against a ball to restrict its oscillation relative to the axis of the main body; and
wherein in the unlocked position, the locking component releases the ball to allow its oscillation relative to the axis of the main body.

2. The supporting stand of claim 1, wherein: in response to the locking assembly slides downward under external force, the movable pin is configured to alternately move between a first movable position and a second movable position on the locking assembly. Under the action of the reset elastic member, the locking assembly enables the movable pin to either move from the first movable position to the locked position, or from the second movable position to the unlocked position.

3. The supporting stand of claim 2, wherein the limiting component is fixed axially relative to the main body and arranged for circumferential rotation, while the movable pin is radially movably connected to the outer periphery of the limiting component.

4. The supporting stand of claim 3, wherein: a limiting elastic member being disposed between the limiting component and the movable pin, wherein the limiting elastic member drives one end of the movable pin to extend radially outward from the outer surface of the limiting component; and a locking component having an inner wall with a guide groove, wherein the extended end of the movable pin protruding beyond the limiting component enters the guide groove.

5. The supporting stand of claim 4, wherein the locked position, the unlocked position, the first movable position, and the second movable position are located at different positions on the guide slot; along the axial direction of the locking assembly, the distance between the locked position and the spherical body is greater than the distance between the first movable position and the spherical body, the distance between the unlocked position and the spherical body is greater than the distance between the second movable position and the spherical body, and the distance between the locked position and the spherical body is greater than the distance between the unlocked position and the spherical body;
wherein, in response to the movable pin is in the locked position and the locking assembly is not subjected to a downward force, the movable pin and the locking assembly abut against each other along the axial direction of the locking assembly, thereby restricting the movement of the movable pin from the locked position to the first operating position;
wherein, in response to the movable pin is in the locked position and the locking assembly is subjected to a downward force, the movable pin moves from the locked position to the second movable position, wherein the movable pin abuts against the locking assembly to define the first downward travel of the locking assembly;
wherein, in response to the movable pin is in the second movable position and the downward force on the locking assembly dissipates, the locking assembly moves upward under the elastic restoring force of the reset spring. The movable pin then transitions from the second movable position to the unlocked position, wherein the movable pin and the locking assembly abut against each other along the axial direction of the locking assembly, thereby preventing the movable pin from moving back to the second movable position from the unlocked position; and
wherein in response to the movable pin is in the unlocked position and the locking assembly is subjected to a downward force, the movable pin moves from the unlocked position to the first movable position, wherein the movable pin then contacts the locking assembly, thereby defining the second downward travel of the locking assembly.

6. The supporting stand of claim 5, wherein the guide slide groove comprises a first elongated groove, a second elongated groove, a first spiral groove, and a second spiral groove. The first elongated groove and the second elongated groove are both parallel in their longitudinal direction to the axial direction of the main body. The first spiral groove has its two ends connected to both the first elongated groove and the second elongated groove, while the second spiral groove has its two ends also connected to both the first elongated groove and the second elongated groove.

7. The supporting stand of claim 6, wherein (a) the depth of the first spiral groove at its connection with the first elongated groove is greater than that of the first elongated groove, enabling the movable pin to slide along the first spiral groove into the second elongated groove; (b) the depth of the second spiral groove at its connection with the second elongated groove is greater than that of the second elongated groove, allowing the movable pin to slide through the second spiral groove into the first elongated groove.

8. The supporting stand of claim 7, wherein: the first movable position and the locked position being located at opposite ends of the first elongated groove, while the second movable position and the unlocked position are positioned at opposite ends of the second elongated groove.

9. The supporting stand of claim 6, wherein the first elongated groove, the first spiral groove, the second elongated groove and the second spiral groove are arranged in sequence along the circumferential direction of the inner wall surface of the locking assembly;
wherein, in response to the number of the guide slide groove is a group, the first strip groove and the second spiral groove are connected at the beginning and end, and the guide slide groove is through along the circumferential surface of the inner wall of the locking assembly;
wherein, in response to multiple guide grooves are arranged in groups, these grooves are evenly distributed circumferentially along the inner wall of the locking assembly. The first elongated groove of the front group connects with the second helical groove of the rear group, while all guide grooves extend through the entire circumference of the locking assembly's inner surface. The movable pin may slide alternately within these multiple guide grooves.

10. The supporting stand of 4, wherein the locking assembly comprises an outer sleeve coaxially arranged with main body and an inner sleeve, wherein the outer sleeve is slidably engaged with main body, while the inner sleeve is fixed inside the outer sleeve; wherein the guide slide groove is formed on the inner wall surface of the inner sleeve.

11. The supporting stand of claim 10, wherein the inner sleeve is formed by splicing together a plurality of arc-shaped plates.

12. The supporting stand of claim 10, wherein the outer peripheral wall of the outer sleeve is provided with a plurality of notch grooves, the groove openings of the notch grooves being opposite to the spherical body.

13. The supporting stand of claim 10, wherein a housing cavity is formed between the outer sleeve and the inner sleeve, and the reset elastic member is at least partially accommodated in the housing cavity.

14. The supporting stand of claim 3, wherein: a positioning shaft coaxially arranged with the main body is fixed inside the main body; the positioning assembly is rotatably connected around the axis of the positioning shaft; and a positioning step is provided on the positioning shaft to block the side of the positioning assembly away from the main body.

15. The supporting stand of claim 14, wherein the locking assembly has a central shaft hole at its center, and the central shaft hole is slidably engaged with the limiting shaft along the axial direction of the limiting shaft.

16. The supporting stand of claim 1, wherein the spherical body is provided with a hole opening toward a plug hole of the locking assembly; the locking assembly has a locking protrusion at its end facing the spherical body; said locking protrusion extends into said plug hole to restrict the spherical body from swinging relative to the axis of the main body of the stand.

17. The supporting stand of claim 16, wherein the locking protrusion is frustum-shaped with a small upper part and a large lower part, and the insertion hole of the spherical body is conical in shape identical to the locking protrusion.

18. The supporting stand of claim 1, wherein the upper end of the rotating cavity is provided with a top opening, and the spherical body is connected with a connecting head extending out of the rotating cavity from the top opening; the connecting head is used to connect an external component.

19. The supporting stand of claim 18, wherein the external component is used to connect a support rod or the central rod for supporting photographic equipment.

20. The supporting stand of claim 1, wherein the main body of the leg frame further comprises a sliding cavity located at its lower end. The locking assembly is slidably arranged along the axial direction of the main body within the sliding cavity, and is circumferentially fixed relative to the main body.

21-25. (canceled)
